(19) United States
(12) Patent Application Publication
(10) Pub. No.: US 2007/0119885 A1
(43) Pub. Date: May 31, 2007

(54) Floor console with reconfigurable storage

(75) Inventors: Thomas Anthony Miller, Royal Oak, MI (US); Nancy E. Thacker, Auburn Hills, MI (US); Joel Thomas Runyan, Canton, MI (US)

Correspondence Address: CARLSON, GASKEY & OLDS, P.C., 400 WEST MAPLE ROAD, SUITE 350, BIRMINGHAM, MI, 48009, US

(73) Assignee: Toyoda Gosei Co. Ltd.

(21) Appl. No.: 11/454,429

(22) Filed: Jun. 15, 2006

Related U.S. Application Data
(60) Provisional application No. 60/740,066, filed on Nov. 28, 2005.
(60) Provisional application No. 60/755,763, filed on Jan. 3, 2006.
(60) Provisional application No. 60/755,940, filed on Jan. 3, 2006.

(51) Int. Cl. A45F 5/00; B60R 7/00; B60R 7/06

(52) U.S. Cl. 224/275; 224/483; 224/183

(57) ABSTRACT

A storage system for a vehicle passenger compartment provides reconfigurable storage for cds, trash and other items. The storage system includes multiple portable storage containers that are selectively mountable at several optional locations in the vehicle passenger compartment, or storable inside a floor console. One of the example portable storage containers is a cd sleeve and the other example portable storage container is a receptacle, such as for trash storage. In the example embodiments, the portable storage containers are securable to one of a plurality of interior panels via a magnetic coupling between the portable storage container and the interior panels. Additional mechanical coupling may be provided to prevent the storage containers from slipping on the interior panels. For example, in the portable trash storage receptacle, a protrusion is received in a complementary recess between the container wall and the interior panel, in order to prevent the container from sliding. The protrusion may include the magnet of the magnetic coupling. Preferably, the portion of the magnetic coupling that is formed on the interior panel is hidden behind an outer trim surface and does not protrude from the interior panel.

This application claims priority to U.S. Provisional Application Ser. No. 60/740,066, filed Nov. 28, 2005, and U.S. Provisional Application Ser. Nos. 60/755,763 and 60/755,940, both filed Jan. 3, 2006.

### BACKGROUND OF THE INVENTION

Storage in vehicles is always an issue. Space is limited and different potential owners have different preferences and needs for storage.

For example, trash storage in vehicles has been a difficult issue. Vehicle owners, especially those with children, need readily accessible trash storage in the vehicle. However, different owners have different preferences for the location of the trash storage, depending on the location of passengers in the vehicle who need to access the trash storage. Auto makers are reluctant to provide permanent trash storage in the vehicle for esthetic reasons, and have thus largely left the issue of trash storage to after-market products. These after-market products are not tailored to any specific vehicle and have not provided acceptable trash storage solutions.

Also, many vehicles are now equipped with cd players as part of the in-vehicle entertainment system. Although many of the vehicles include cd players that hold more than one cd, the typical user has more cds in the vehicle than can be held within the player. Thus, there is still a need to store cds in the vehicle outside the cd player.

One known cd storage device is a sleeve having a plurality of overlapping flaps forming pockets, each of which holds a cd. The sleeve includes straps for securing the sleeve to the sun visor in the vehicle. One drawback of this device is that the sleeve can interfere with the operation of the sun visor in some vehicles. Also, the sleeve cannot be easily removed from the visor by the driver because the driver must flip down the visor in order to access the cds.

### SUMMARY OF THE INVENTION

The present invention provides an improved storage system for a vehicle passenger compartment, including storage for cds and trash. The storage system includes multiple portable storage containers that are selectively mountable at several optional locations in the vehicle passenger compartment, or storable inside a floor console. One of the example portable storage containers is a cd sleeve and the other example portable storage container is a receptacle, such as for trash storage. Other portable storage containers could also be included.

In the example embodiments, the portable storage containers are securable to one of a plurality of interior panels via a magnetic coupling between the portable storage container and the interior panels. Additional mechanical coupling may be provided to prevent the storage containers from slipping on the interior panels. For example, in the portable trash storage receptacle, a protrusion is received in a complementary recess between the container wall and the interior panel, in order to prevent the container from sliding. The protrusion may include the magnet of the magnetic coupling. Preferably, the portion of the magnetic coupling that is formed on the interior panel is hidden behind an outer trim surface and does not protrude from the interior panel.

The portable receptacle is roughly sized to accommodate plastic grocery bags. The portable receptacle may provide hooks or other connectors near a bottom end of the container. The loop handles of the plastic grocery bag can be secured to the hooks or connectors to keep the bag properly positioned in the container.

The console has one or more storage areas for removably storing the cd storage sleeve. The cd storage sleeve can be easily removed from at least some of the storage areas with one hand (e.g. without opening the console). The cd storage sleeve does not occupy a significant amount of console storage volume.

### BRIEF DESCRIPTION OF THE DRAWINGS

Other advantages of the present invention can be understood by reference to the following detailed description when considered in connection with the accompanying drawings wherein:

FIG. 1 is a front perspective view of a console according to one embodiment of the present invention.

FIG. 2 is a perspective view of the forward portion of the console of FIG. 1, with the cd storage tray in the open position.

FIG. 3 is a rear view of the console of FIG. 1, with the lid closed.

FIG. 4 illustrates an instrument panel of the vehicle in which the console of FIG. 1 is installed. the panel to which it is attached.

FIG. 6 is a section view of the trash container, illustrating attachment of a bag to the container.

FIG. 7 is a rear perspective view of an alternative forward portion of the console of FIG. 2.

FIG. 8 is a section view taken along line 8-8 of FIG. 7.

### DETAILED DESCRIPTION OF THE PREFERRED EMBODIMENT

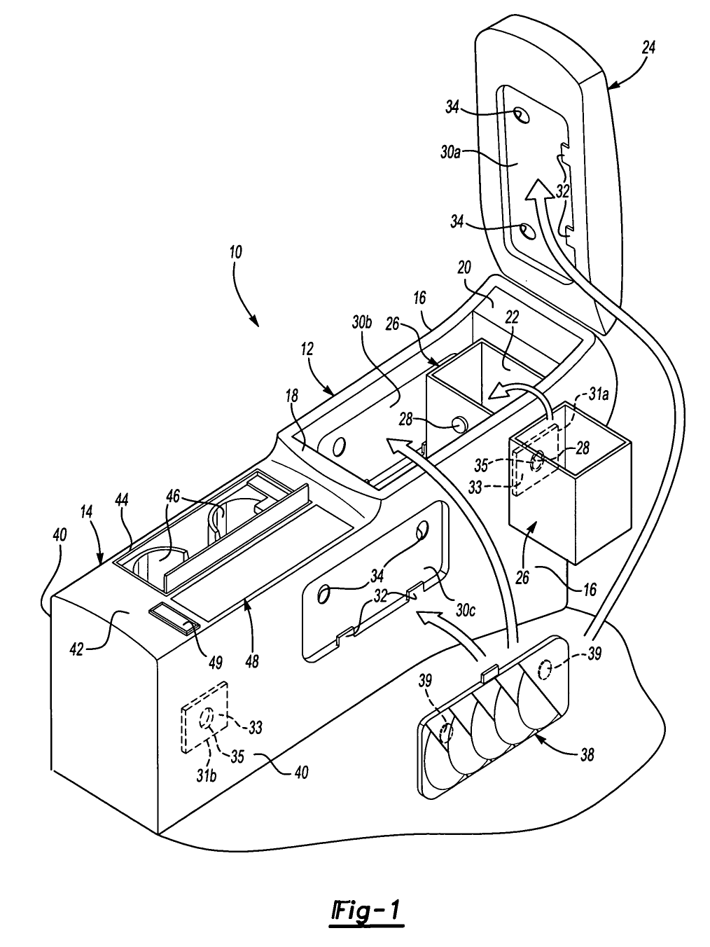

A floor console 10 according to the present invention is shown in FIG. 1. The floor console 10 generally includes a console box 12 and a forward console portion 14. The console box 12 includes console walls including a pair of opposed sidewalls 16 and a rear wall 20 defining an interior compartment 22. A lid 24 is pivotably secured to the rear wall 20 to selectively cover an opening to the interior compartment 22. The lid 24 is pivotable between a closed position covering the interior compartment 22 and an open position as shown.

A plurality of storage containers can be secured to various locations in and on the floor console 10. Two example containers shown include a cd sleeve 38, for holding a plurality of cds, and a receptacle, such as a portable trash container 26. A plurality of mounting areas (designated as recesses 30 and connection points 31) are formed on various surfaces of the console 10. The cd sleeve 38 and/or the portable trash container 26 can be removably secured to each of the mounting areas 30, 31. The occupants of the vehicle can arrange the cd sleeve 38 and portable trash container 26 as desired or needed.

The portable trash container 26 may be a molded plastic receptacle and can be removably stored inside the interior compartment 22. The trash container 26 includes a fastener, such as a magnet 28, secured to an exterior surface. The magnet 28 may alternatively be mounted to an interior surface or insert-molded with the trash container 26. In the embodiment shown, the magnet 28 is secured to the exterior surface and protrudes from the exterior surface of the trash container 26. A single round magnet 28 is shown, but one or more magnets of other shapes could be used. Other fasteners (hooks, Velcro®, etc) could be used in place of or in addition to the magnet 28.

The forward console portion 14 includes a pair of spaced-apart sidewalls 40 and an upper wall 42 defining a forward interior compartment 44. Cup holders 46 are formed in the forward interior compartment 44 for holding cups or bottles, etc.

A plurality of connection points 31a-b (two shown in FIG. 1) are formed on several surfaces of the console 10. A first connection point 31a is formed on an exterior surface of one of the sidewalls 16 of the console box 12. A second connection point 31b is formed on an exterior surface of one of the sidewalls 40 of the forward console portion 14. Each connection point 31a,b includes a magnetic plate 33 behind or insert-molded within the sidewall 16, 40 and an optional recess 35 molded into the sidewall 16, 40.

Optionally, the magnet 28 could be provided on the connection point 31 and the magnetic plate 33 could be provided on the trash container 26. Although round recesses 34 are shown, other shapes could be used. Also, more than one recess 35 could be provided at each connection point 31. Alternatively, the recess 35 can be eliminated for a completely hidden connection point 31. If fasteners other than a magnet 28 are formed on the trash container 26, then suitable complementary fasteners would be provided at the connection points 31; however, it is preferred that the fasteners on the connection points be non-protruding connectors (i.e. do not protrude from the surface of the sidewall 16, 40 or other interior trim panel), both for esthetic reasons and safety.

The trash container 26 is shown connected to the connection point 31a. The magnet 28 on the trash container 26 is received in the recess 35 and is magnetically secured to the magnetic plate 33. The trash container 26 can easily be moved to either connection point 31a,b or returned to the interior compartment 22. In the embodiment shown, there is a single trash container 26 shown at two optional locations in FIG. 1; however, in an optional feature of the present invention, a plurality of trash containers 26 may be provided, such that they can be mounted at multiple locations. The trash containers 26 may be of slightly different sizes, such that they can nest one within the other inside the interior compartment 22 of the console 10 when not in use. The trash containers 26 may optionally be connected to one of the plurality of recesses 30.

The plurality of recesses 30a-c are formed on several surfaces of the console 10. A first recess 30a is formed on the underside of the lid 24. A second recess 30b is formed on an interior surface of one of the sidewalls 16. A third recess 30c is formed on an exterior surface of the other sidewall 16. Each recess 30a-c includes a pair of upwardly-protruding tabs 32 on a lower edge thereof. A pair of magnets 34 are mounted to (or recessed within or hidden behind) the interior surface of each recess 30a-c adjacent an upper edge of the recess 30a-c. Alternatively, other fasteners, such as Velcro, clips, dual lock, etc. could be used in place of the magnets 34.

Each of the recesses 30a-c can receive the cd storage sleeve 38. One cd storage sleeve 38 can be provided, such that it can be stored in the recess 30a-c selected by the user, or alternatively, a cd storage sleeve 38 can be provided for each one of the recesses 30a-c (in which case, the cd storage sleeves 38 are preferably interchangeable, if not identical). The bottom edge of the cd storage sleeve 38 is received behind the upwardly-protruding tabs 32. Magnets 39 secured to (or held within) the upper edge of the cd storage sleeve 38 releasably secure the cd storage sleeve 38 within the recess 30a-c.

A vertically-slidable, spring-operated cd storage tray 48 is formed through the upper wall 42 of the forward console portion 14. The cd storage tray 48 can be released by pressing a release button 49 on the upper wall 42 or the storage tray 48 can be spring-loaded such that it is released by pressing down on the top of the storage tray 48.

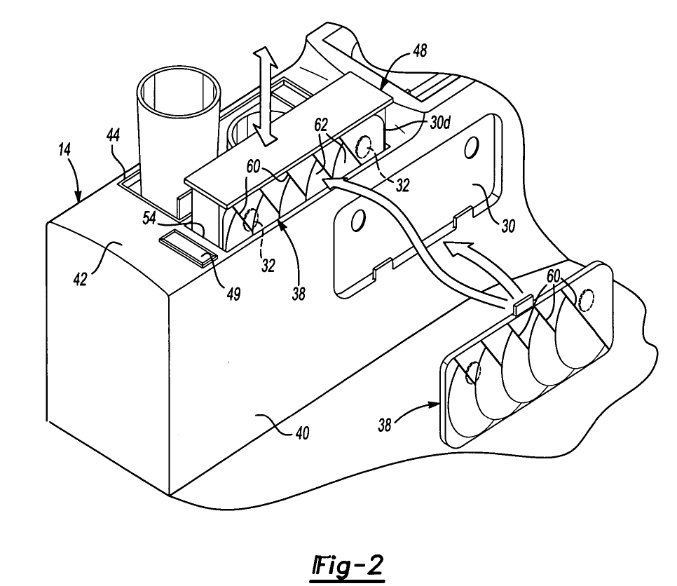

In FIG. 2, the cd storage tray 48 is shown in the open position so that the cd storage sleeve 38 can be removed from or inserted into a recess 30d (similar to recesses 30a-c of FIG. 1). The cd storage sleeve 38 is retained by tabs 32 and magnets (not shown in FIG. 2).

The cd storage sleeve 38 includes a plurality of pockets 60 each capable of receiving a cd 62. The cd storage sleeve 38 and the manner of retaining the cd storage sleeve 38 within the recesses 30a-d make it possible for the driver to retrieve a cd 62 using only one hand. The driver can even access the cd storage sleeve 38 in the recess 30d in the cd storage tray 48 or in the recess 30c on the exterior of the console box 12 without opening the lid 24 on the console box 12. The recesses 30a-c occupy a minimal amount of storage volume in the console box 12.

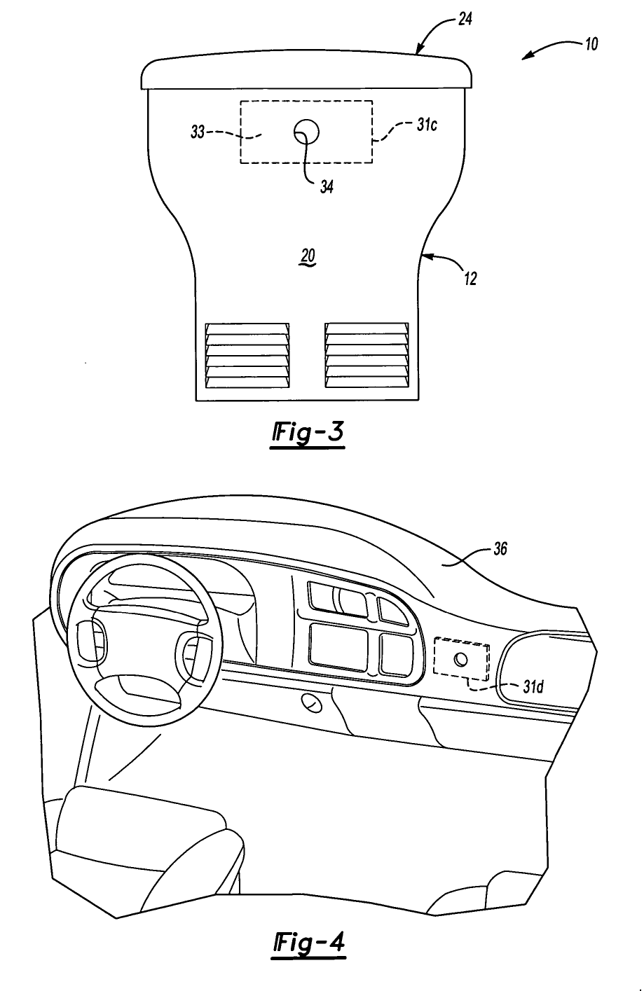

Referring to FIG. 3, an additional connection point 31c, similar to connection points 31a,bis formed on the rear wall 20 of the console box 12. Referring to FIG. 4, another connection point 31d is formed on an instrument panel 36. Additional connection points 31 at other locations in the vehicle could also be formed. The trash container 26 can be moved to any of the connection points 31. Optionally, the cd sleeve 38 could be secured to the connection points 31.

FIG. 5 is a sectional view through one wall of the trash container 26 and the sidewall 16, 40. As shown, the magnet 28 on the trash container 26 is received in the recess 35 (to prevent slippage) and is magnetically secured to the magnetic plate 33 hidden behind the sidewall 16, 40 (or any interior panel, wherever the connection point 31 is provided). Alternatively, the magnet 28 could be mounted inside or behind the wall of the trash container 26, in which case a protrusion for being received in the recess 35 could be molded into the wall of the trash container 26. Multiple protrusions and recesses 34 could also be used. Thus, as shown in FIG. 5, the magnetic plate 33 is not visible and does not affect the appearance of the vehicle interior; however, the recess 35 provides to the user a subtle indicator of where the trash container 26 can be mounted.

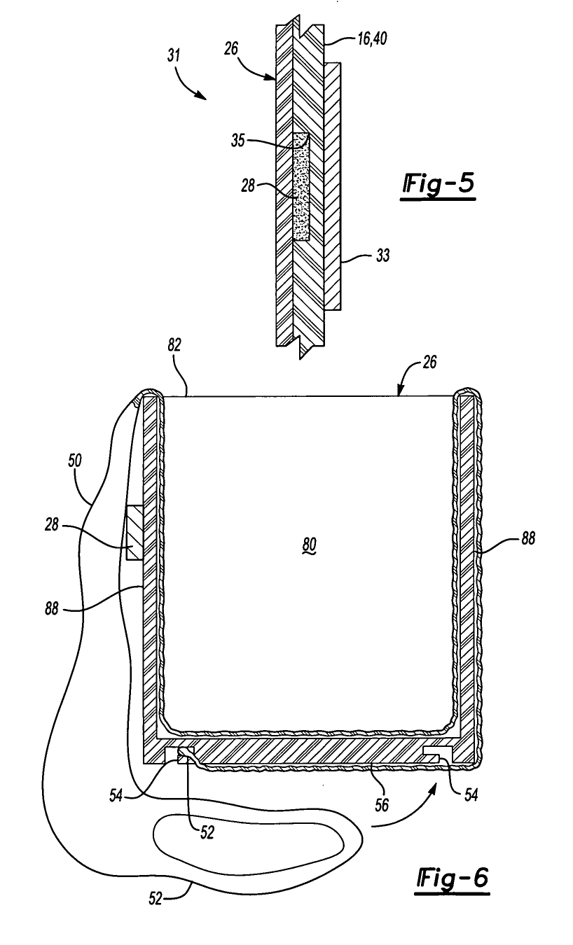

Referring to FIG. 6, the trash container 26 is preferably sized to accommodate a typical plastic grocery bag 50 having loop handles 52. Hooks 54 are molded near the bottom of the trash container 26, such as on the bottom wall 56 of the trash container 26. The hooks 54 connect to the handles 52 to retain the bag 50 in the trash container 26. The magnet 28 is not affected by the bag 50. By accommodating the readily-available plastic grocery bags 50, the users will be able to easily use and change the bag 50 in the trash container 26.

Still referring to FIG. 6, the trash container 26 includes container walls 58 defining a storage area 60. The bottom wall 56 is opposite an opening 62 to the storage area 60. When secured to any of the connection points 31 (FIGS. 1-5), the opening 62 is oriented upward, in order to hold the bag 50 and trash.

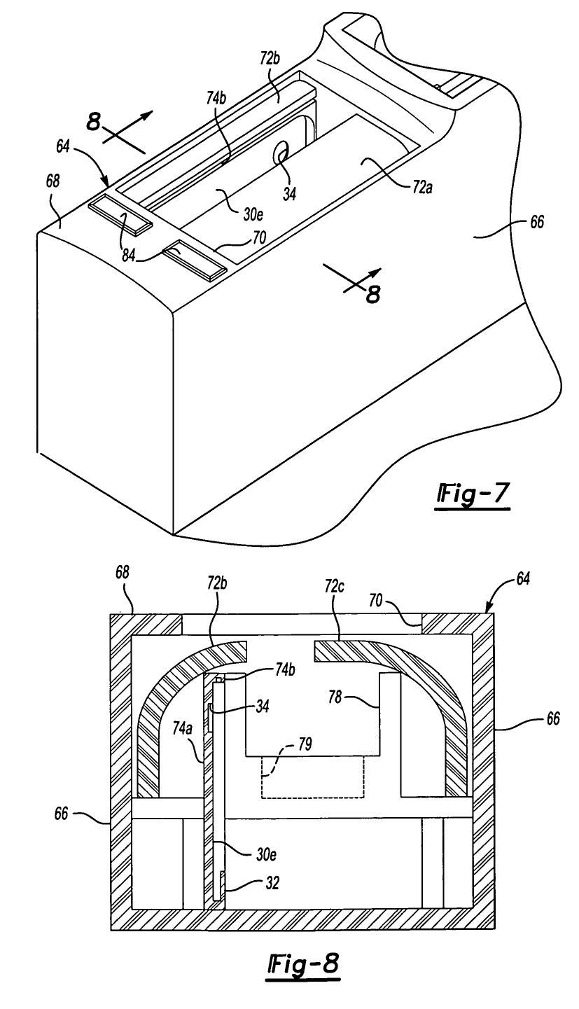

FIG. 7 illustrates an alternative forward portion 64 of the console 10 of FIG. 2. The forward portion 14 includes a pair of opposed sidewalls 66 and an upper wall 68 having an opening 70 formed therein. The opening 70 is selectively closed by sliding, curved doors 72a,b (slidable mounting and springs or motors not shown). In FIG. 8, the door 72a is shown in the closed position, while the door 72b is shown in the open position (for purposes of illustration only—normally, the doors 72a,b would both be either open or both closed). The doors 72a,b slide behind dividers 74a,b respectively in the interior of the forward portion 64 when in the closed position. One of the dividers 74b has an interior surface with a recess 30e that may be somewhat similar to the recesses 30a-d described above with respect to FIGS. 1-2. The recess 30e includes tabs 32 (FIG. 8) (and optionally includes the magnets 34, not shown) for removably retaining the same cd storage sleeve 38 described above. The other divider 74a is adjacent or integral with a cup holder assembly 78, including a plurality of recesses 79 for holding cups.

The doors 72a,b include a spring-loaded or motorized mechanical assembly (not shown) for sliding the doors between the open and closed positions based upon the user activating a switch 84. When the doors 72a,b are open, the user can access the cd storage sleeve 38 stored in recess 30e. The cd storage sleeve 38 is stored between the divider wall 74b and the cup holder assembly 78.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A vehicle storage system comprising:
an interior wall in the vehicle passenger compartment; and
a container having a container wall and a bottom wall defining a storage area, the bottom wall opposite an opening to the storage area, one of the container wall and the interior wall including a protrusion from an outer surface, the other of the container wall and the interior wall including a recess complementary to the protrusion, the container selectively connectable to the interior wall via a magnetic coupling and via the protrusion being received in the recess.

2. The vehicle storage system of claim 1 wherein the magnetic coupling includes a magnet secured to the container wall.

3. The vehicle storage system of claim 1 wherein the magnetic coupling includes a magnetic portion secured behind at least an outer surface of the interior wall.

4. The vehicle storage system of claim 1 further including a floor console, wherein the interior wall defines an interior compartment of the floor console, the container sized to fit within the interior compartment of the floor console.

5. The vehicle storage system of claim 4 wherein the interior wall is a first interior wall, further including a second interior wall that is not part of the floor console, the container selectively connectable to the second interior wall via a magnetic coupling.

6. The vehicle storage system of claim 1 wherein the container opens upwardly when connected to the interior wall.

7. The vehicle storage system of claim 1 wherein the container includes at least one hook near a bottom end of the container, a bag at least partially disposed within the storage area includes a handle looped around the at least one hook.

8. The vehicle storage system of claim 1 further including a cd sleeve having a plurality of pockets for holding cds therein, the cd sleeve removably attachable to the interior wall.

9. The vehicle storage system of claim 8 wherein the recess is a first recess, the interior wall further including a second recess into which the cd sleeve is removably received.

10. The vehicle storage system of claim 9 wherein the magnetic coupling is a first magnetic coupling, the system further including a second magnetic coupling between the interior wall and the cd sleeve.

11. The vehicle storage system of claim 10 further including at least one tab protruding into the second recess, the cd sleeve insertable behind the at least one tab to retain the cd sleeve within the second recess.

12. The vehicle storage system of claim 9 wherein the interior wall is part of a floor console having a hinged lid, the cd sleeve removably attachable to an underside of the hinged lid.

13. A vehicle passenger compartment storage system comprising:
a first interior panel having a first outer trim surface and a non-protruding first connector; and
a portable storage container having a container wall and a bottom wall defining a storage area, the bottom wall opposite an opening to the storage area, the container wall having a second connector complementary to the first connector, the portable storage container selectively securable to the first interior panel via the first connector and the second connector, the portable storage container opening upwardly when secured to the first interior panel.

14. The vehicle passenger compartment storage system of claim 13 wherein the first connector and the second connector magnetically connect to one another.

15. The vehicle passenger compartment storage system of claim 14 wherein the first connector includes a first magnetic portion mounted behind the first outer trim surface and wherein the second connector includes a magnet connected to the container wall.

16. The vehicle passenger compartment storage system of claim 15 further including a second interior panel having a second outer trim surface, a second magnetic portion mounted behind the second outer trim surface, the portable storage container selectively securable to the second interior panel via the magnet and the second magnetic portion.

17. The vehicle passenger compartment storage system of claim 16 wherein the first interior panel includes a first recess formed in the first outer trim surface and the second interior panel includes a second recess formed in the second outer trim surface, the portable storage container including a protrusion from the container wall that is receivable in the first recess and receivable in the second recess.

18. The vehicle passenger compartment storage system of claim 17 wherein the protrusion from the outer surface of the container wall includes the magnet.

19. A vehicle storage system comprising:
an interior wall in the vehicle passenger compartment;
a container having a container wall and a bottom wall defining a storage area, the bottom wall opposite an opening to the storage area, the container wall selectively connectable to the interior wall via a magnetic coupling, the container opening upwardly when connected to the interior wall, the container including at least one hook near a bottom end of the container; and
a bag at least partially disposed within the storage area, the bag including a handle looped around the at least one hook.

20. The vehicle storage system of claim 19 wherein the magnetic coupling includes a magnetic portion hidden behind an outer trim surface on the interior wall.
